(19) United States
(12) Patent Application Publication
(10) Pub. No.: US 2003/0029091 A1
(43) Pub. Date: Feb. 13, 2003

(54) Pivot-tilt mechanism for a door or window

(75) Inventors: Walter Renz, Ditzingen (DE); Michael Neuwirth, Ditzingen (DE)

Correspondence Address: Dreiss, Fuhlendorf, Steimle & Becker, Patentanwalte, Postfach 10 37 62, Stuttgart, D-70032, DE

(73) Assignee: Gretsch-Unitas GmbH, Ditzingen (DE)

(21) Appl. No.: 10/261,664

(22) Filed: Oct. 2, 2002

Related U.S. Application Data
(63) Continuation of application No. 09/761,574, filed on Jan. 18, 2001.

(30) Foreign Application Priority Data
Feb. 11, 2000 (DE) 200 02 467.1

(51) Int. Cl. E05D 15/52

(52) U.S. Cl. 49/246; 49/247; 49/253

(57) ABSTRACT

A pivot-tilt mechanism for a window or a door comprises a transmission (32), groove bands and locks (74, 92). The pivot-tilt mechanism has a pivot fixture (22) and a tilt fixture (24) and the transmission is formed of two parts and comprises a drive (18) for the pivot fixture (22) and a drive (20) for the tilt fixture (24). The pivot fixture (22) and the tilt fixture (24) are driven one after the other.

This application is a continuation of Ser. No. 09/761,574 filed Jan. 18, 2001 and claims Paris Convention priority of DE 200 02 467.1 filed on Feb. 11, 2000 the entire disclosure of which are hereby incorporated by reference.

### BACKGROUND OF THE INVENTION

The invention concerns a pivot-tilt mechanism for a window, a door or the like comprising a transmission, groove bands and locks.

Fixtures of this kind are described in the following patent literature: U.S. Pat Nos. 4,035,953, 4,339,892 and GB 214 76 57 A the entire disclosures of which are hereby incorporated by reference.

Windows or doors which can be pivoted about a vertical axis and also be tilted about a horizontal axis are well known. These windows or doors have a pivot-tilt mechanism which is driven via a transmission operated by a handle to displace the groove bands in the window or door sash. The turning handle usually has three positions with one position being the closed position from which the turning handle can be rotated through 90° into the pivot position. In this pivot position, the window or door can be pivoted about the vertical axis and be opened. If the turning handle is pivoted further by 90°, with the door or window closed, the fixture is in its tilting position and the door or window can then be tilted about a horizontal axis. The door or window is usually held by bracket tongs which engage on the upper edge of the door or window. Disadvantageously, the tilted door or window cannot assume an intermediate position, i.e. can be tilted only until the bracket tongs limit the tilting motion.

It is therefore the underlying purpose of the invention to provide a pivot-tilt mechanism which permits tilting of the door or window into intermediate positions.

### SUMMARY OF THE INVENTION

This purpose is solved in accordance with the invention in that a pivot-tilt mechanism of the above mentioned type is provided with a pivot fixture and a tilt fixture, wherein the transmission is formed of two parts and comprises a drive for the pivot fixture and a drive for the tilt fixture. The pivot fixture and the tilt fixture are driven sequentially, one after the other.

In the inventive pivot-tilt mechanism, the door or window is released via the pivot fixture to assume a pivoted position. Towards this end, only the pivot fixture is driven by a separate drive. For tilting the door or window, the pivot fixture is brought into an end position opposite to a locked position of the window or door sash in which a side of the door or window is secured to a stationary frame about which the door or window sash is to be tilted. When the pivot fixture is in this end position, the tilt fixture is driven and the door or window sash is gradually brought from its closed position within the stationary frame into its tilted position. The further the tilt fixture is driven, the larger the opening angle of the tilted door or window sash. The pivot-tilt mechanism in accordance with the invention permits greater or less tilting of the door or window sash in dependence on the extent to which the tilt fixture is driven. When the tilt fixture is in its other end position opposite to the closed position of the pivot fixture, the door or window sash assumes its fully tilted position.

Importantly, tilting of the door or window sash is not effected by the pivot fixture (which also drives the sash locking mechanism). Rather, tilting of the door or window sash is effected by a separate tilt fixture which is driven independently of the pivot fixture.

The pivot fixture can preferably be driven when the tilt fixture assumes a neutral position and vice versa. The pivot fixture and the tilt fixture cannot be driven at the same time but only one after the other, i.e. one fixture can be driven only when the other fixture assumes a neutral or resting position.

In accordance with an embodiment, the transmission comprises a central translating part which drives a first translating part for the pivot fixture and a second translating part for the tilt fixture. The central translating part is driven e.g. via a central drive, e.g. a turning handle, a crank or the like. The first translating part and subsequently the second translating part are moved by means of the central translating part to drive the pivot fixture and then the tilt fixture. The translating parts have the essential advantage that they are relatively flat and can therefore be easily accommodated in the door or window sash.

In accordance with an embodiment of the invention, the first and second translating parts are coupled to the central translating part such that the central translating part always moves only one of the two other translating parts. Coupling or decoupling of the two translating parts to or from the central translating part is effected by means of a coupling which automatically couples one translating part when the other translating part is in the corresponding end position and is decoupled. The drive motion is then transferred e.g. from the pivot fixture to the tilt fixture or vice versa.

Another embodiment provides that the transmission can be driven via a crank. A crank advantageously permits finer adjustments, as is particularly advantageous for tilting the door or window sash. In this fashion, it is possible to set almost any intermediate position between the completely closed and completely tilted position of the door or window sash. The transmission can also be driven via a motor to permit remote control tilting of the door or window sash.

The transmission preferably comprises a toothed gearing, in particular a differential gearing. Differential gearing are widely known and have the advantage that transmission of relatively large forces is possible. The lever arm of the crank can therefore be relatively short. Tilting and closing of relatively heavy doors or windows is still possible.

The pivot fixture and tilt fixture are coupled to the transmission in that the pivot fixture cooperates with a first toothed rack section and the tilt fixture cooperates with a second toothed rack section which are part of the transmission. The transmission directly engages the pivot fixture and tilt fixture via the toothed rack sections and displaces them in the door or window sash. Importantly, either the pivot fixture or the tilt fixture are driven and each are driven sequentially, one after the other.

In a preferred embodiment, the drive for the pivot-tilt mechanism comprises a housing and the toothed rack sections are disposed next to or on top of one another within the housing and are driven by two toothed wheels disposed one on top of the other. The two toothed wheels are motion-coupled. The two toothed wheels have teeth on a portion of their circumference and successively engage the toothed racks, one after the other. These two toothed wheels, which are preferably commonly driven, first move one toothed rack section from its first end position into its second end position and the other toothed rack section is then driven and brought from its first end position into its second end position. During this motion, the pivot-tilt mechanism is brought from that position locking the door or window sash into that position which completely opens the door or window sash.

A further development provides that each of the two toothed rack sections can be fixed to the housing of the pivot-tilt mechanism via a locking device such that only one toothed rack section can be driven via the transmission. The locking device prevents simultaneous movement of the two toothed rack sections. The non-driven toothed rack section is preferably secured with respect to undesired displacement, thereby ensuring that the toothed rack sections assume their neutral positions when the drive changes from one toothed rack section to the other. The same is true for the above-mentioned translating parts.

In accordance with a preferred embodiment, the locking device comprises a locking element which is driven by a toothed rack section and connects the other toothed rack section to the housing and vice versa. This locking element is driven by a toothed rack section every time same reaches its neutral or end position. Then, the other toothed rack section is released such that it can leave its end position thereby locking the other toothed rack section in the previously assumed end position. This locked toothed rack section is released only when the other toothed rack section has returned into its end position and releases the locking element.

The locking element may e.g. be a sphere or a cylindrical roller which engages in openings of the toothed rack section. Since the sphere or roller is fixed by the housing, and since the housing is mounted within the sash, that toothed rack section into which the sphere or roller engages is fixed relative to the door or window sash.

In accordance with a preferred embodiment, the locking element assumes an unlocking position for each change from one drive for the pivot fixture to the other drive for the tilt fixture or vice versa. The two fixtures are always locked in their respective end position such that the two fixtures are not driven simultaneously.

The tilt fixture preferably communicates with a tilt shackle which is connected to the transmission. The door or window sash is tilted about the horizontal axis and out of the stationary door or window frame via this tilt shackle. The conventional bracket tongs provided on the upper side of the sash for tilting are then no longer required and optionally serve to secure and guide the door or window sash.

For pivoting the door or window sash about a vertical axis when the mechanism assumes the pivot position, the free end of a pivot shackle can be hooked into a closing plate provided on the stationary frame. The closing plate consists of two members, with one member being formed by a translating part which opens and closes the closing plate. When the closing plate is open, the free end of the pivot shackle, in particular a pin provided at the free end, can be hooked into the closing plate and fixed therein. The closing plate is always open when the pivot fixture assumes its released position and the locks are opened such that the door or window sash can be turned about the vertical axis.

The tilt shackle is preferably detachably mounted on the tilt fixture and can be replaced by a longer or shorter tilt shackle to thereby change the maximum opening angle of the door or window sash for adjustment of the opening angle to door or window sashes of different heights.

Further advantages, features and details of the invention can be extracted from the dependent claims and the following description which describes in detail two particularly preferred embodiments with reference to the drawing. The features shown in the drawing and mentioned in the claims and in the description may be important to the invention either individually or collectively in any arbitrary combination.

### BRIEF DESCRIPTION OF THE DRAWING

FIG. 1 is a view of a conventional, prior art turning or tilting window equipped with a single handle operated turn and tilt mounting;

FIG. 2 is a detailed view of the operating handle of the window according to the prior art of FIG. 1 with alternative positions of the handle being indicated by means of dashed lines;

FIG. 2a is a detailed view of the operating handle according to the prior art of FIG. 2;

FIG. 2b is a side view of the operating handle according to FIG. 2a;

FIG. 3 is a detailed view of the tensioning unit for the flat strip of the mounting according to the prior art of FIG. 1;

FIG. 3a is a side view of the tensioning unit according to FIG. 3;

FIG. 3b is a side view of the tensioning unit according to FIG. 3a;

FIG. 4 is a detailed view of one of the securing devices of the mounting for the prior art window according to FIG. 1;

FIG. 4a is a plan view of the securing device according to FIG. 4;

FIG. 4b is a section through the securing device according to FIG. 4 taken along the line IVb-IVb;

FIG. 4c is a section through the section of FIG. 4b taken along the line IVc-IVc;

FIG. 4d is an enlarged view of the securing pin of the securing device according to FIG. 4;

FIG. 5 is a detailed view of the tilting device of the window mounting according to the prior art of FIG. 1;

FIG. 5a is a section through the tilting device according to FIG. 5 taken along the line Va-Va;

FIG. 5b is a section through the tilting device according to FIG. 5 taken along the line Vb-Vb;

FIG. 5c is a side view of the tilting device according to FIG. 5, with the window in the partly tilted position;

FIG. 5d is a side view of the tilting device according to FIG. 5, with the window in the partly tilted position;

FIG. 5e is a side view of the tilting device according to FIG. 5 when the window is in the turned position;

FIG. 5f is a side view of the tilting device according to FIG. 5 when the window is closed;

FIG. 6 is a detailed view of one of the corner link members of the prior art window mounting according to FIG. 1;

FIG. 6a is a plan view of the corner link member according to FIG. 6;

FIG. 6b is a side view of a corner link member according to FIG. 6;

FIG. 6c is a detailed view of a corner link member according to FIG. 6;

FIG. 6c is a detailed view of the cover for the corner link member according to FIG. 6;

FIG. 6d is a side view of the cover according to FIG. 6c;

FIG. 7 is a detailed view of the casement side hinge plate with the supporting member and the associated basic portion of the corner link member of the turn hinge of the window mounting according to the prior art of FIG. 1;

FIG. 7a is a detailed view of the casement-side mounting of the turn hinge of the window mounting according to FIG. 7a;

FIG. 7b is a plan view of the mounting according to FIG. 7a;

FIG. 7c is a plan view of the hinge plate of the turn hinge according to FIG. 7;

FIG. 8 is a plan view of the opening stay of the prior art window mounting according to FIG. 1 with a window in the fully tilted position;

FIG. 8a is a plan view of the opening stay according to FIG. 8 with the window in the partly tilted position;

FIG. 8b is a plan view of the opening stay according to FIG. 8 with the window in the turning position;

FIG. 8c is a plan view of the opening stay according to FIG. 8 with the window in the closed position;

FIG. 8d is a plan view of the adjustment device of the window mounting according to FIG. 1 attached to the guide rail of the opening stay;

FIG. 8e is a side view of the adjustment device according to FIG. 8d;

FIG. 8f is a section through the adjustment device according to FIG. 8e taken along the line VIIIf-VIIIf;

FIG. 9 shows a perspective view, partly broken away, of a crank-driven pivot-tilt mechanism in accordance with the invention, mounted to a door or window sash or casement;

FIG. 10 shows a view in the direction of arrow II according to FIG. 9 onto the lower side of the sash or casement;

FIG. 11 shows a view in the direction of arrow III according to FIG. 9 with removed housing;

FIG. 12 shows a perspective illustration of the crank-driven pivot-tilt mechanism in accordance with the invention without housing and without the door or window sash or casement;

FIG. 13 shows a perspective view of the crank-driven pivot-tilt mechanism according to FIG. 9, however, without its housing and without the door or window sash or casement;

FIG. 14 shows a side view of a door or window sash having the pivot-tilt mechanism in accordance with the invention with associated stationary frame, in the closed and tilted positions;

FIG. 15 shows a perspective representation of an embodiment of a differential transmission in accordance with the invention;

FIG. 16 shows a view in the direction of arrow VIII according to FIG. 15 onto the differential transmission; and

FIG. 17 shows an exploded view of a further embodiment of a drive in accordance with the invention.

### DESCRIPTION OF THE PREFERRED EMBODIMENT

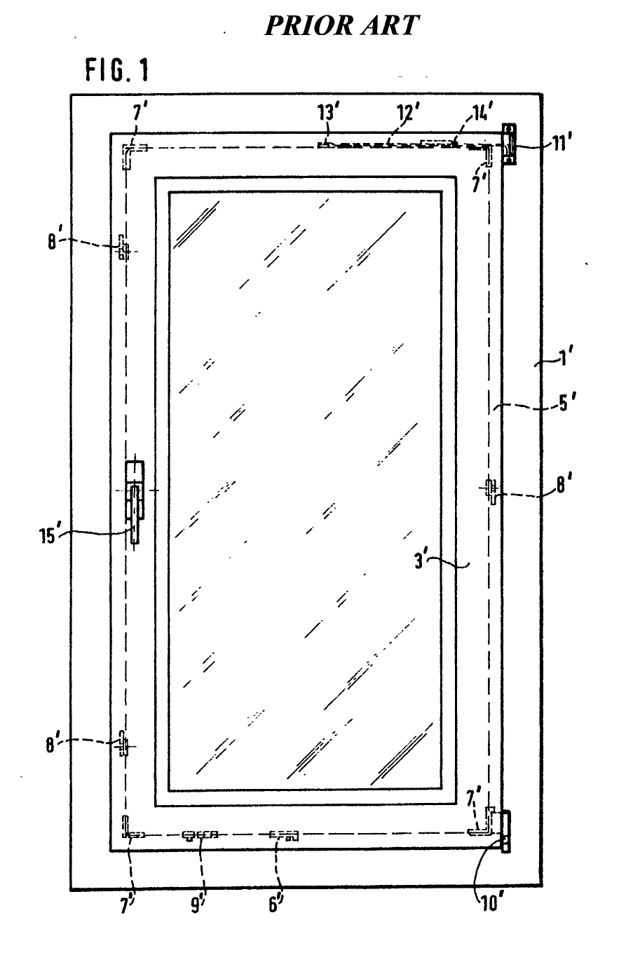

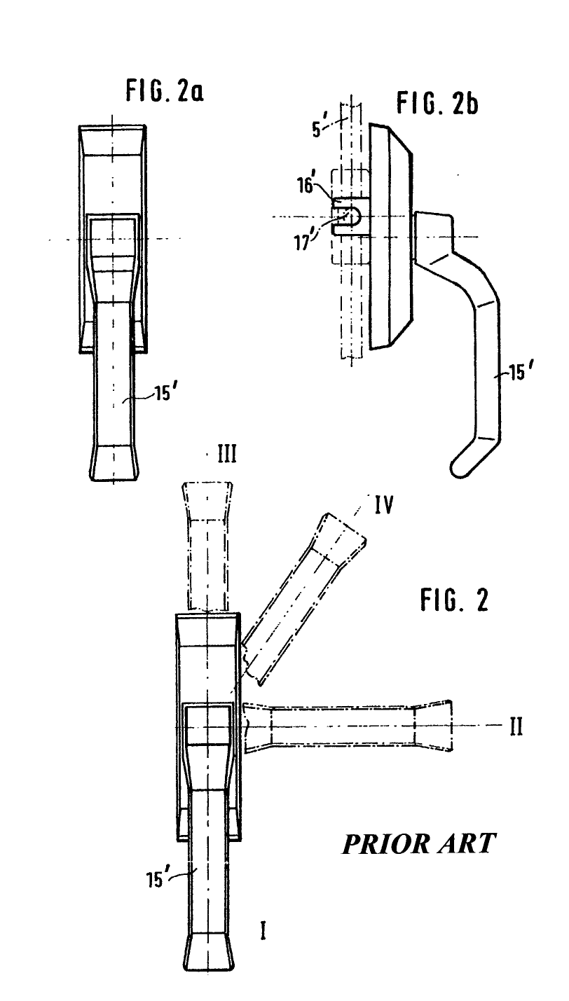

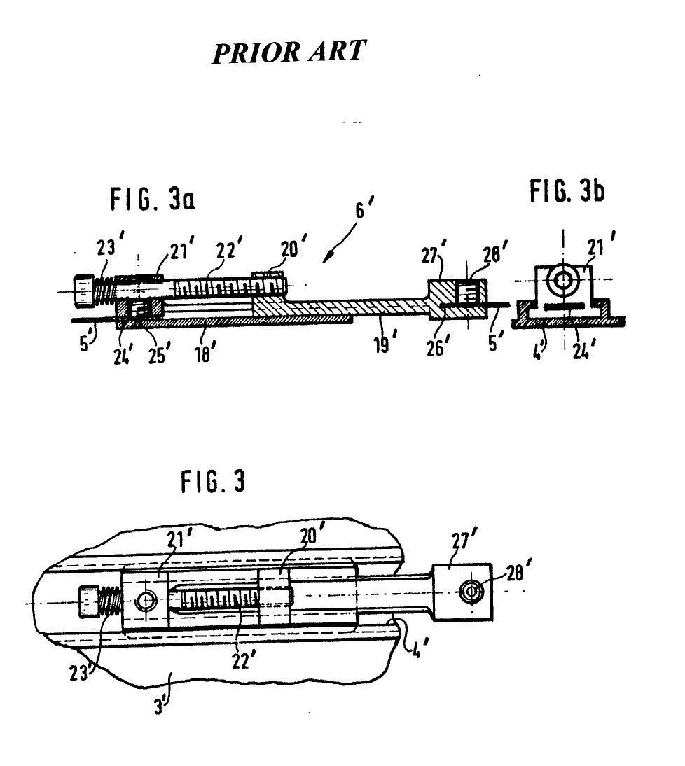

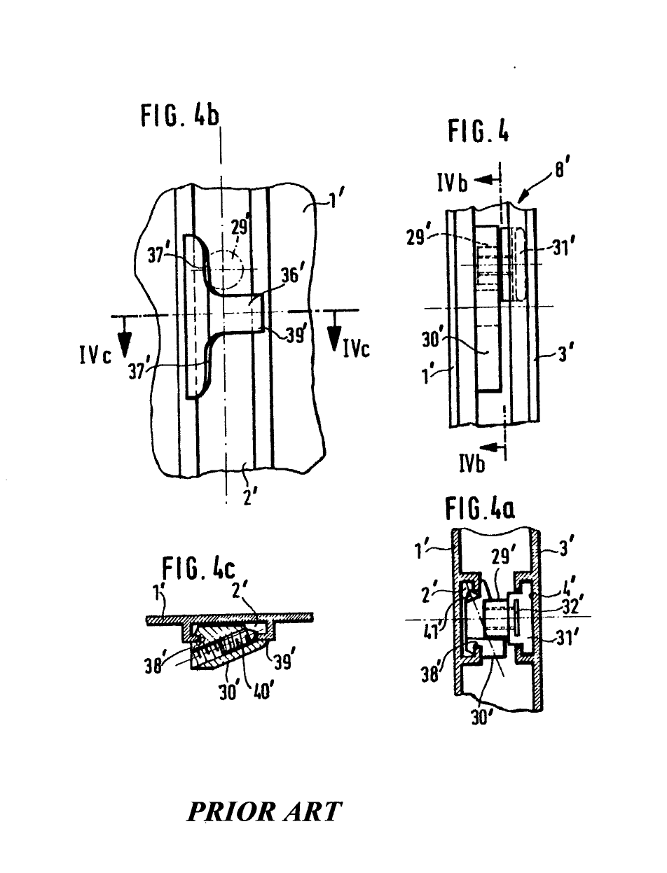

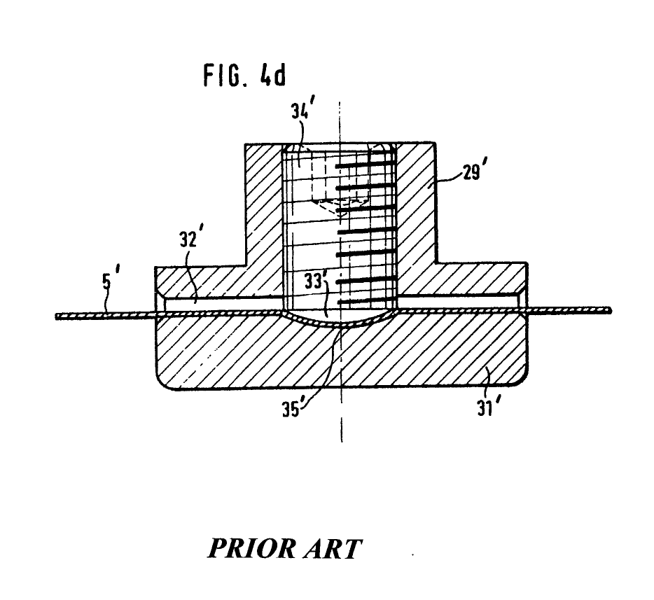

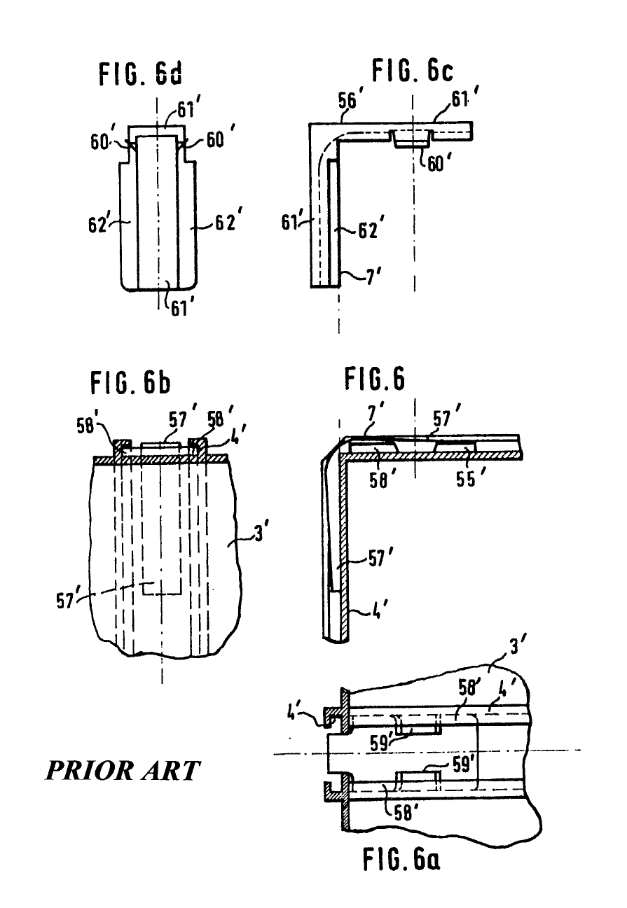

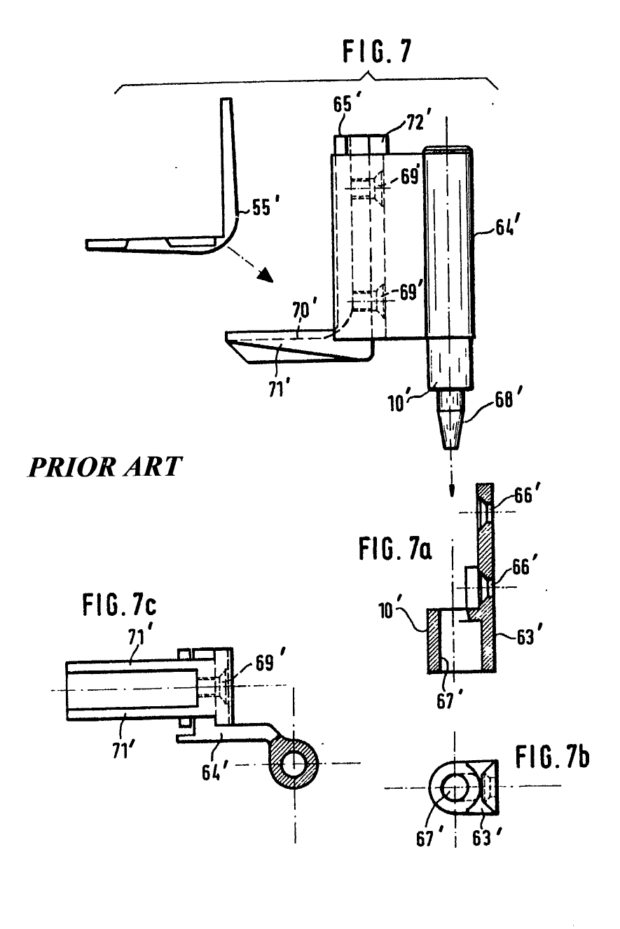

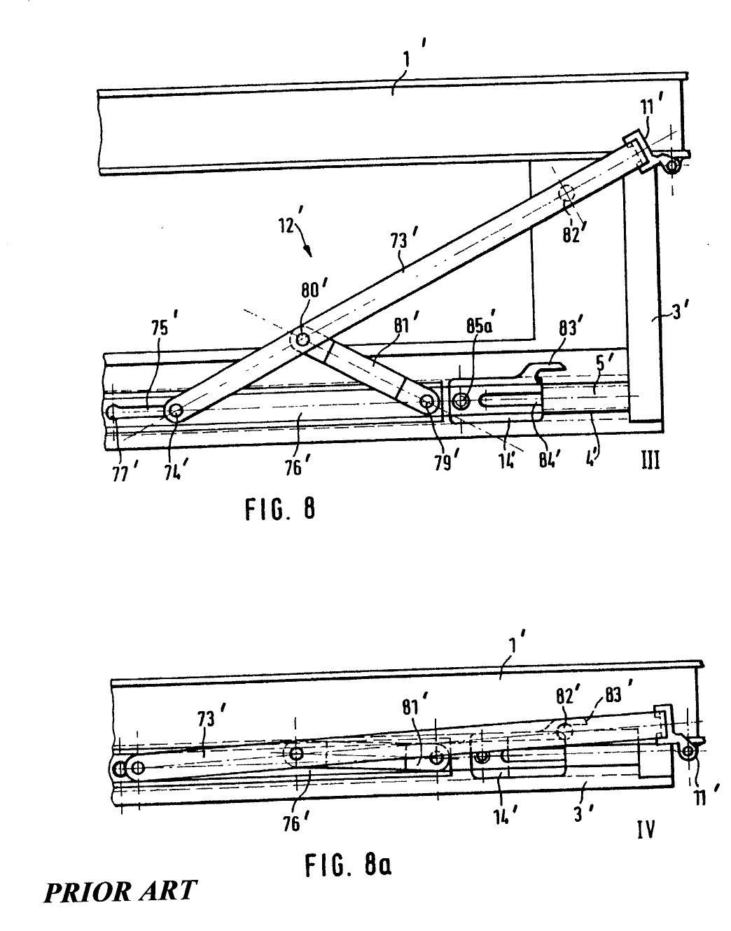

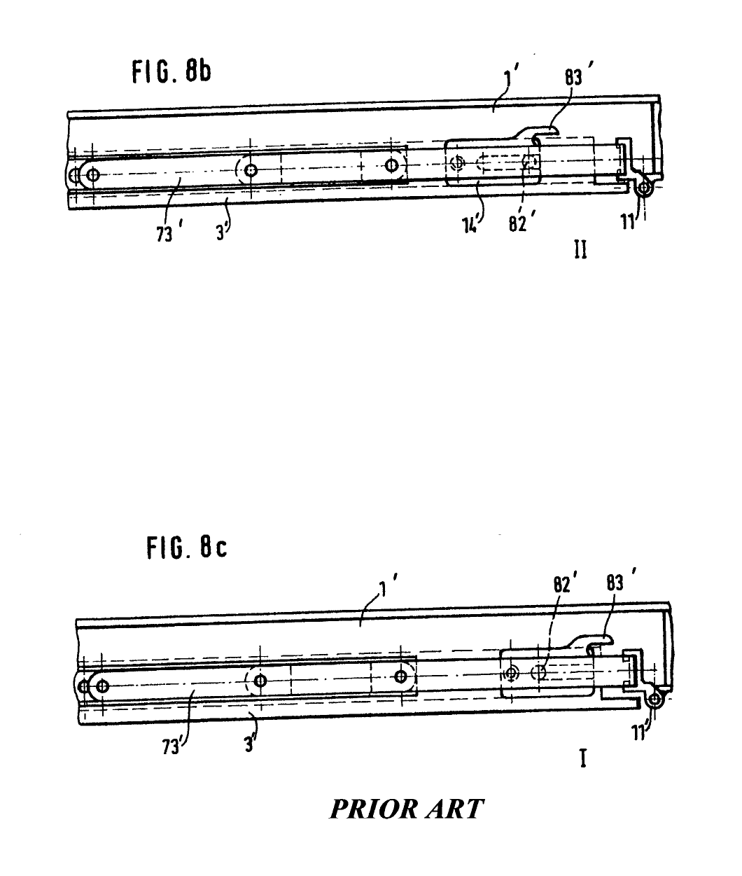

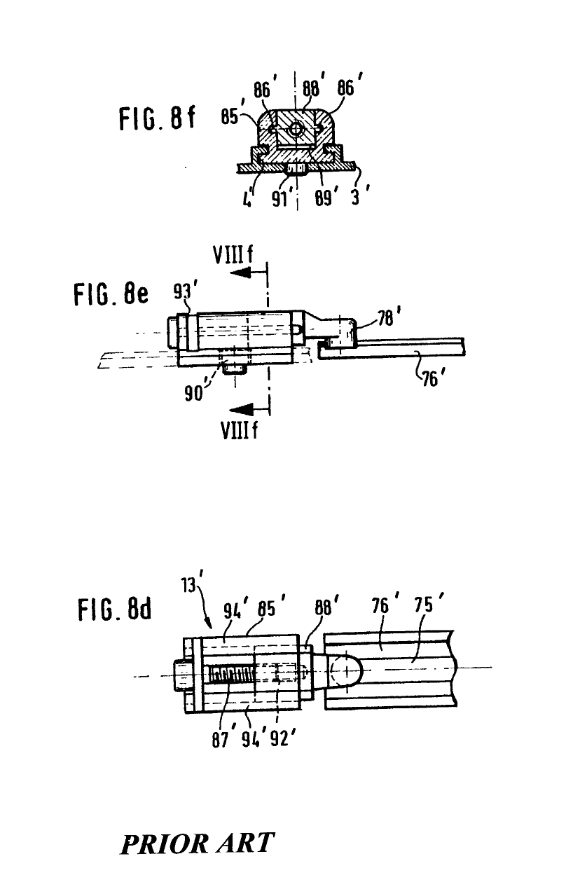

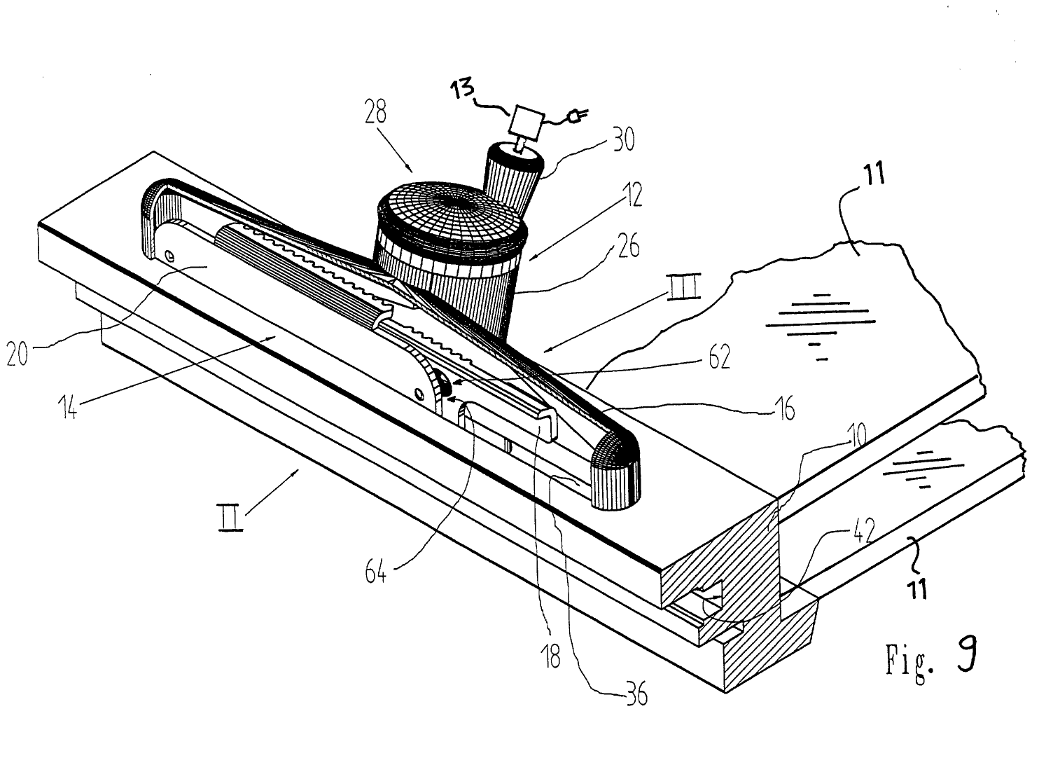

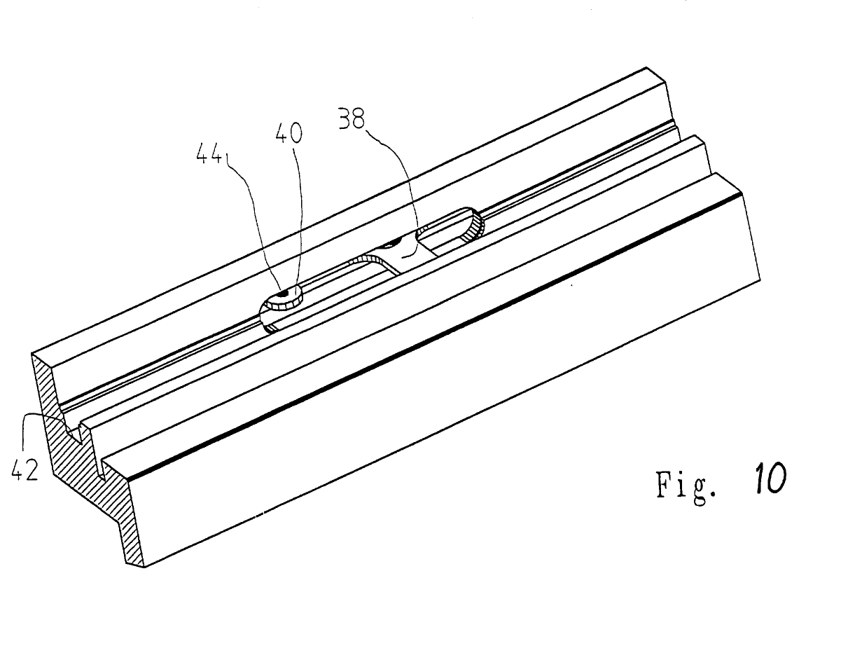

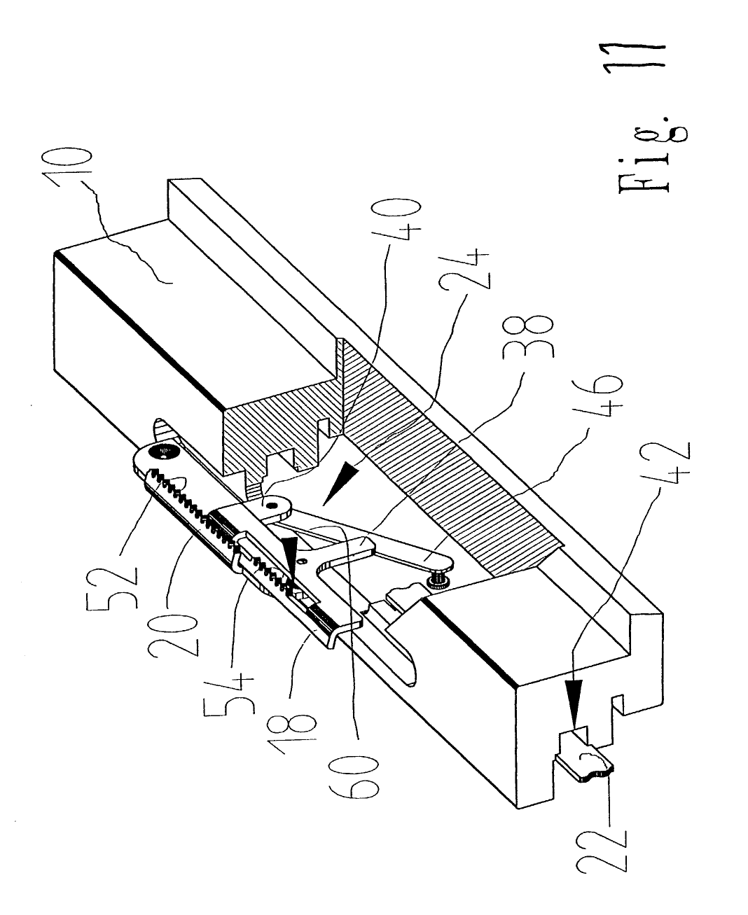

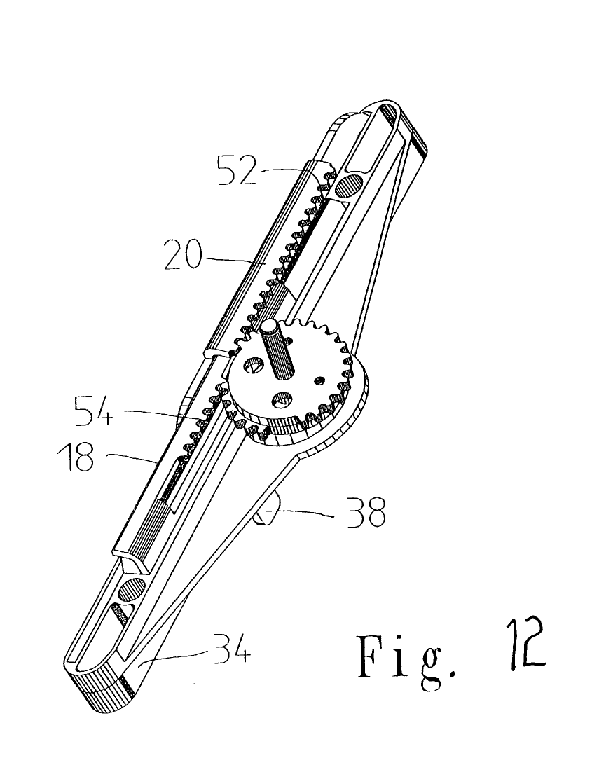

The function of the preferred embodiment of the pivot-tilt mechanism in accordance with the invention will now be described, initially through comparison to a conventional mechanism of prior art as illustrated in FIGS. 1 to 8f.

The prior art window of FIGS. 1 to 8f (GB 2 147 657A) is constructed as a turning or tilting window and comprises a window frame 1′ incorporating a guide channel 2′ and a casement 3′ set therein, the guide channel 4′ of which lies opposite the guide channel 2′ of the window frame 1′. The window frame 1′ and the casement 3′ preferably are formed of hollow aluminium section. A slidably movable, encircling, flat strip 5′ of metal, the ends of which are held together by means of a tensioning unit 6′, is located in the guide channel 4′ of the casement 3′. Securing devices 8′ are attached at several points to the flat strip 5′ which is guided by means of special, angled, corner link members 7′. A tilting device 9′, which permits hopper-hung movement of the window is located between the bottom bar of window frame 1′ and the bottom bar of casement 3′. A lower pivot hinge 10′ and an upper pivot hinge 11′ are attached to casement 3′ and permit side-hung movement of the window. Pivot hinge 11′ is attached by means of an articulated link to opening stay 12′, which is provided on one side with an adjustment device 13′ and on the other side with a securing member 14′ attached to the flat strip 5′, linked to the opening stay 12′.

The flat strip 5′ is displaced by means of an operating handle 15′ having an integral positioning lock, which is not illustrated, on the outside of casement 3′, the internal prong 16′ of which handle slidably grips an attachment pin 17′ connected to the flat strip 5′. If the operating handle 15′ is pulled downwards then casement 3′ lies in the closed position I. When operating handle 15′ is in the horizontal position, the casement 3′ can move in the turning or pivoting position II. If the operating handle 15′ is turned upwards, then the casement 3′ lies in the fully tilted position III, while if the operating handle 15′ is placed between the turning position II and the fully tilted position III, then the casement 3′ occupies the partly tilted position IV which is also known as the ventilation gap position.

The tensioning unit 6′, which serves to compensates for changes in length in the encircling flat strip 5′ in the guide channel 4′ of the casement 3′, consists of a locating member 18′ which is slidably mounted in the guide channel 4′ of the casement 3′ and into which a connecting piece 19′ is slidably inserted. Connecting piece 19′ has an attachment portion 20′ into which a tensioning bolt 22′ is inserted after passing through an attachment portion 21′ of the locating member 18′. A compression spring 23′ is located between the attachment portion 21′ of the locating member 18′ and the head of the tensioning bolt 22′. An opening 24′ in the attachment portion 21′ of the locating member 18′ allows one end of the flat strip 5′ to be inserted into the tensioning unit 6′. This end of the flat strip 5′ is clamped by means of a hexagon socket screw 25′ having a spherically shaped end which acts in association with a corresponding opposing recess in locating member 18′ screwed into the attachment portion 21′ of the locating member 18′ beneath the tensioning bolt 22′. The other end of the flat strip 5′ is held in a slot 26′ in an attachment member 27′ to the connecting member 19′ of the tensioning unit 6′ and is secured in this position by means of a hexagon socket screw 18′ having a spherically shaped end which acts in association with a corresponding opposing recess in the attachment member 27′ screwed into the said member 27′. In order that the length of the flat strip 5′ which is to be laid in the guide channel 4′ of the casement 3′ need not be accurately determined, the distance between the attachment portion 20′ of the connecting member 19′ and the attachment portion 21′ of the locating member 18′ is made relatively large. The flat strip 5′ is thus permanently tensioned by means of the compression spring 23′ of the tensioning unit 6′.

Each of the required number of securing devices 8′ attached to the flat strip 5′ consists of a securing pin 29′ on the casement side and a locking plate 30′ on the frame side. Securing pin 29′ consists of an attachment member 31′ which is formed in a single piece, is slidably guided in the guide channel 4 of the casement 3 and is provided with a corresponding opening 32′ for passage of the flat strip 5′. The ends of the opening 32′ in the attachment member 31′ of the securing pin 29′ are formed in a conical shape so that the flat strip 5′ may more easily be inserted. The flat strip 5′ is firmly clamped between the spherically shaped end 33′ of a hexagon socket screw 34′ screwed into the securing pin 29′ and extending into the opening 32′ in the attachment member 31′ and an opposing recess 35′ in the attachment member 31′ and an opposing recess 35′ in the attachment member 31′ of the securing pin 29′ which is shaped to correspond with the end 33′ of the hexagonal socket screw 34′. The attachment pin 17′ for operating handle 15′ is secured to the flat strip 5′ in a similar manner to the damage-free mounting of the flat strip 5′ on the securing pin 29′.

The locking plate 30′, which acts in association with the securing pin 29′, consists of two inclined surfaces 37′ separated by a central projection 36′ for the securing pin 29′ for right and left side use. Each inclined surface 37′ of the striking plate 30′ runs on the one side to the central projection 36′ and is inclined on the other side to the base of the guide channel 2′ in the window frame 1′. The locking plate 30′ is held in position by means on the one hand of the full width recess 38′ which engages one of the angled flanges of the guide channel 2′ of the window frame 1′ and on the other hand by means of a hexagon socket screw 40′ having a spherically shaped end 41′, which bears against the underside of the corresponding angle flange of the guide channel 2′ of the window frame 1′ which passes obliquely through recess 38′ to the lower half of projection 36′ and which rests with an attachment 39′ on the other opposing flange of the guide channel 2′ of the window frame 1′. When the locking plate is secured in this way it is secured simultaneously in the horizontal and vertical directions.

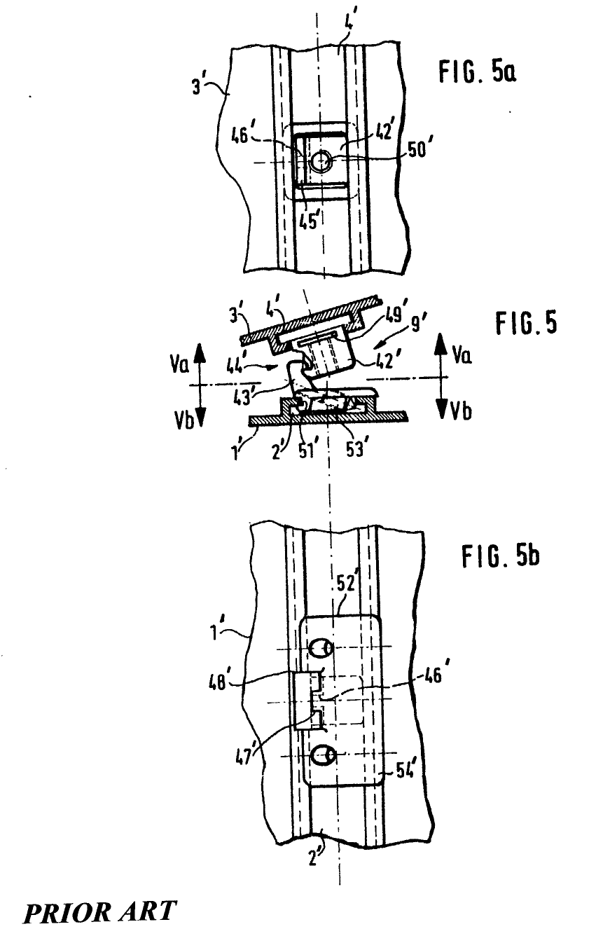

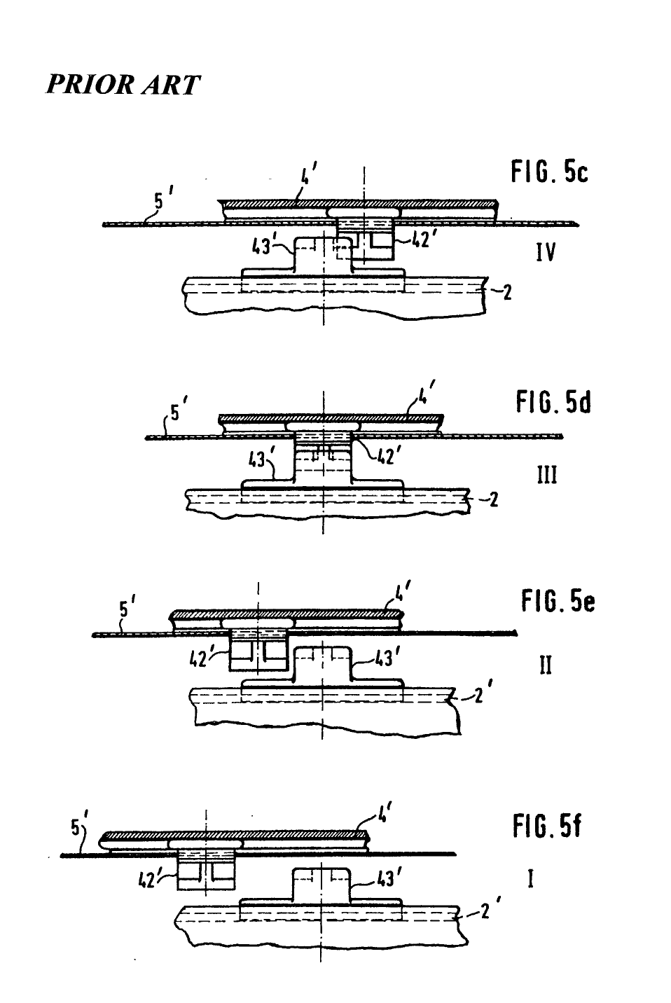

The tilting device 9′ includes a securing member 42′ on the casement side and a tilt mounting 43′ on the frame side. In the fully tilted position III and the partly tilted position IV, securing member 42′ engages tilt mounting 43′ by means of a hook connection 44′. Hook 45′ of securing member 42′ has a central notch 46′ which engages a corresponding recess 47′ in hook 48′ of tilting mounting 43′ when the casement 3′ is in the fully tilted position III. The securing member 42′, which is slidably guided in the guide channel 4′ of the casement 3′, has a conically shaped opening 49′ at its ends for passage of the flat strip 5′. The flat strip 5′ is firmly clamped in position by means of a hexagon socket screw 50′ with a spherically shaped end which acts in association with a corresponding opposing recess in the securing member 42′ set into the securing member 42′ and extending into the opening 49′. The tilting mounting 43′ is secured on the one hand by means a full width recess 51′ in base 52′ of tilt mounting 43′, which engages one angled flange of the guide channel 2′ of the window frame 1′, and on the other hand by two hexagon socket screws 53′ set laterally in a base 52′ to the side of projecting hook 48′ of the tilting mounting 43′. Hexagon socket screws 53′ run obliquely to beneath the full width shoulder of the tilting mounting 43′ which rests on the other angled flange of the guide channel 2′ of the window frame 1′, the spherically shaped ends thereof resting against the under edge of the associated flange of the guide channel 2′. Again in this case, the tilting mounting 43′ is simultaneously secured in the vertical and horizontal directions. FIGS. 5c to 5f indicate the position of the securing member 42′ with respect to the tilting mounting 43′ when the casement 3′ is in the partly tilted position IV, the fully tilted position III, the turning position Ii and the closed position II.

Every corner link member 7′, which is manufactured from plastics material consists of a basic member 55′ and an associated cover 56′. Basic member 55′ has two arms 57′ to guide the flat strip 5′, only one arm 57′ being provided with lateral guides 58′ to grip the angled flanges of the guide channel 4′ of the casement 3′. The inclined surfaces of the arms 57′ of the basic member 55′ for the flat strip 5′, rise towards their rounded junction at the corner in order to reduce the friction area of the flat strip 5′. The lateral guides 58′ of one arm 57′ of the basic member 55′ are provided with opposing openings 59′ through which the corresponding clip projections 60′ of one arm 61′ of cover 56′ grip behind the angled flange of the guide channel 4′ in the casement 3′. Only the other arm 61′ of cover 56′ has lateral guides 62′ for insertion in the guide channel 4′ of the casement 3′. The surfaces of the arms 57′ of the basic member 55′ which support the flat strip 5′ are provided with a metal coating in order to reduce the friction of the flat strip 5′.

The pivoting or turning hinge 10′ consists of a mounting 63′, hinge plate 64′ and locating member 65′. The mounting 63′ is secured to the window frame 1′ by means of two screws in openings 66′ and is provided with a hole 67′ to take one of the conical pins 68′ formed on the hinge plate 64′. The hinge plate 64′ is attached to locating member 65′ by means of screws 69′. The screws 69′ extend only as far as the inner side 70′ of the locating member 65′. The angled locating member 65′, set in the guide channel 4′ of the casement 3′, acts simultaneously as a cover for the basic member 55′ of the corner link member 7′ located in its vicinity. The horizontally running arm of the locating member 65′ is provided with lateral supports 71′ for the casement, while a support 72′ lying on the hinge plate 64′, by means of which the load is taken off screws 69′, is attached to the vertically running arm of the locating member 65′ at its upper end.

The hinge 11′, linked to the window frame 1′, carries stay 73′ of the opening stay 12′. The free end of the stay 73′ is provided with a guide pin 74′ which projects which projects into a long slot 75′ of guide rail 76′ which is set in the guide channel 4′ of the casement 3′. The length of the long slot 75′ determines the angle of projection of the casement 3′ in the fully tilted position III as guide pin 75′ strikes the end of the long slot 75′ on the hinge side. The other end of the long slot 75′ is provided with an enlarged recess 77′ which is engaged by a pin 78′ of the adjustment device 13′ which is fitted in the guide channel 4′. At the end of the guide rail 76′, opposite the long slot 75′, is a pivoting linkage 79′ which bears a guide bar 81′, attached by means of a pivot linkage 80′, to stay 73′. A securing pin 82′ is positioned eccentrically on the stay 73′ between the pivot linkage 80′ and the pivot or turning hinge 11′. This securing pin 82′ engages behind a prominent projection 83′ of the securing member 14′ connected to the flat strip 5′ when the casement 3′ is in the partly tilted position IV and with a central recess 84′ in the securing member 14′ when the casement 3′ is in the turning position II or the closed position I. The securing member 14′, guided in the guide channel 4′ of the casement 3′ is provided with an opening for the passage of the flat strip 5′. The flat strip 5′ is firmly clamped between the spherically shaped end of a hexagon socket screw set into the upper side of the securing member 14′ and extending into the opening and an opposing recess in securing member 14′ corresponding to the end of hexagon socket screw 85a′.

The adjustment device 13′ consists of a basic member 85′ secured in the guide channel 4′ of the casement 3′ and a slider 88′ which is slidably, guided in the basic member 85′ by guide 86′ and fixed in its position by means of a screw 87′, the shaped pin 78′ of which engages recess 77′ of the long slot 75′ of the guide rail 76′ of the opening stay 12′. The flat strip 5′ is guided through the adjustment device 13′ by means of a corresponding gap 89′ between the slider 88′ and the basic member 85′. The basic member 85′ of adjustment device 13′ is secured in the guide channel 4′ of the casement 3′ by means of a stud bolt 90′ which is threaded into the base of the basic member 85′, the shank 91′ of which bolt, set into a corresponding hole in the guide channel 4′, is smaller in diameter than the diameter of the thread. The bolt 87′ which is threaded into a threaded long hole 92′ of the slider 88′ of the adjustment device 13′ rests with its head against a plate 95′ which is loosely inserted in corresponding recesses 93′ inside walls 94′ of the basic member 85′ and is provided with a hole for passage of the shank of the bolt. The position of the casement 3′ can be adjusted by corresponding rotation of bolt 87′.

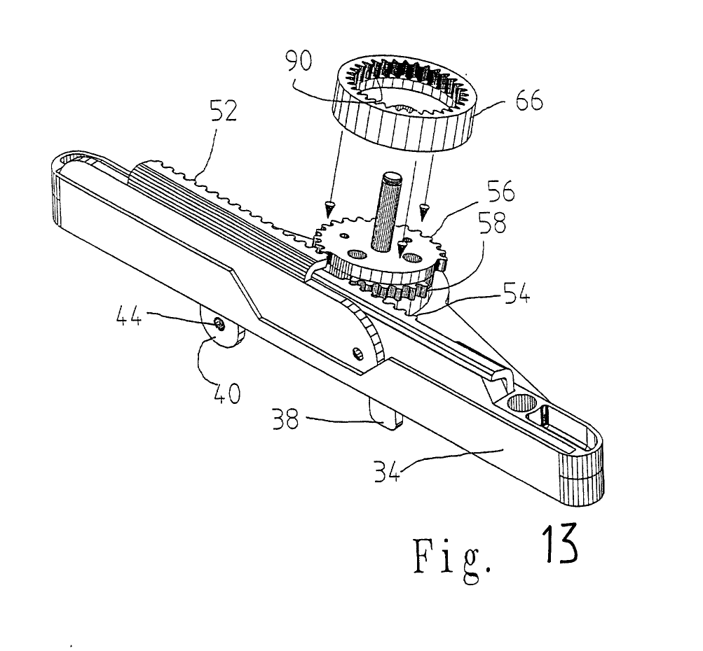

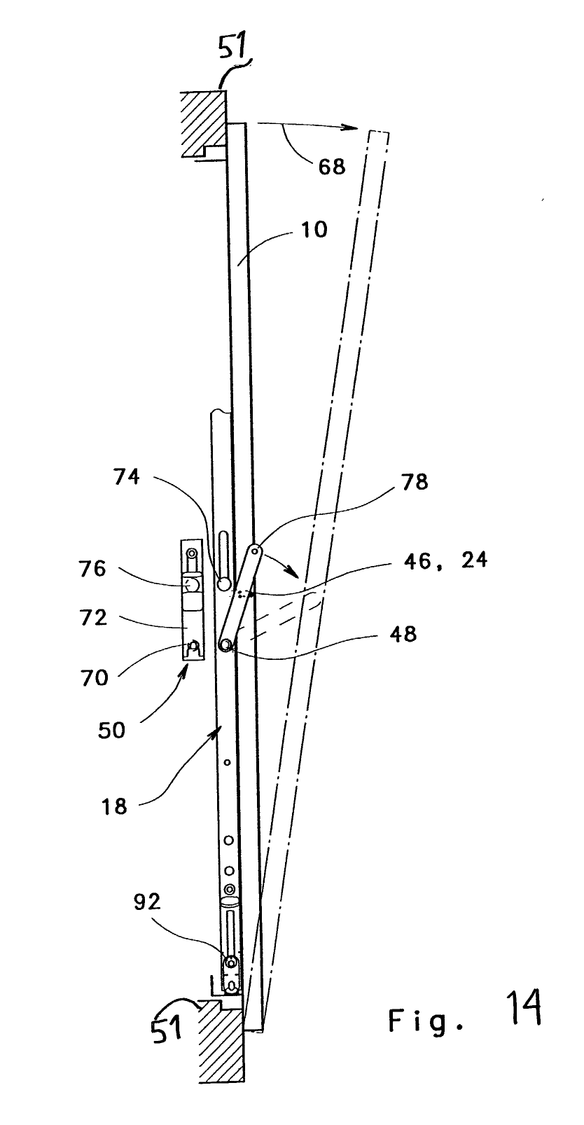

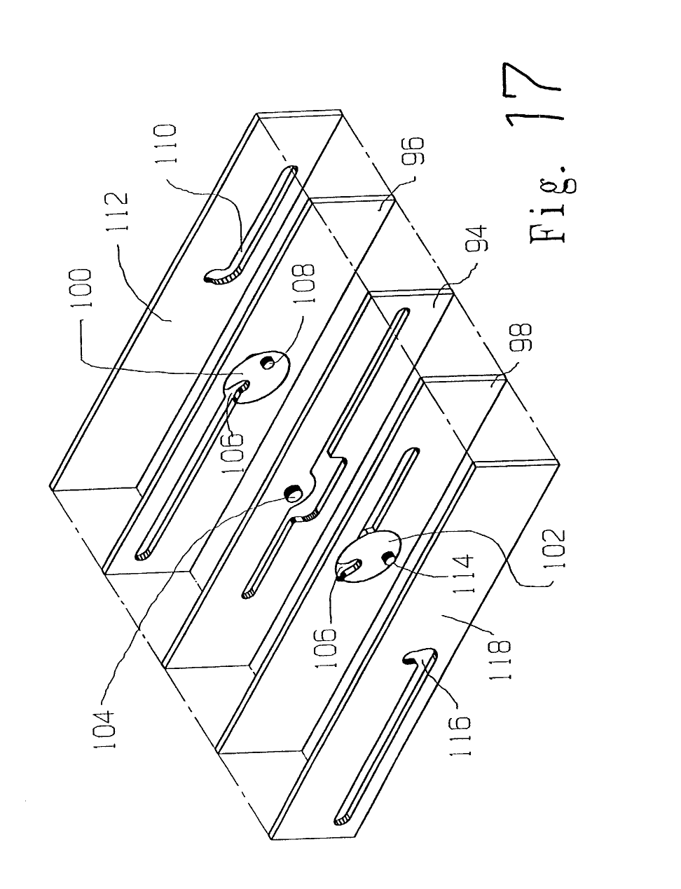

Turning from the above discussion of prior art in association with FIGS. 1 to 8f, FIGS. 9 to 17 illustrate preferred embodiments of the pivot-tilt mechanism in accordance with the invention. FIG. 9 shows a perspective view of part of a door or window sash or casement 10 on which the housing 12 of a first embodiment of a drive for a crank-driven pivot-tilt mechanism 14 in accordance with the invention has been mounted. The housing 12 is partly broken away such that parts of the pivot-tilt mechanism 14 are visible. The housing 12 comprises a longitudinal section 16 accommodating two drives 18 and 20 for a pivot fixture portion 22 or tilt fixture portion 24 respectively (shown in FIG. 11). On the side next to the longitudinal section 16, there is a cylindrical section 26, in the direction towards a sheet of glass 11 (window pane), on which a crank 28 is disposed. The crank 28 is provided with a crank handle 30 for actuating the pivot-tilt mechanism 14. A differential transmission 32, for driving the drives 18 and 20, is provided within the cylindrical section 26 (shown in more detail in FIGS. 15 and 16). The crank handle 30 can be driven by an electric motor 13.

The two drives 18 and 20 are coupled but can only be longitudinally displaced one after the other, i.e. in the longitudinal direction of the door or window sash 10 and within a guiding bed 34 (shown in FIG. 13). This guiding bed 34 has a longitudinal structure and is inserted into a matching recess 36 in the door or window sash 10.

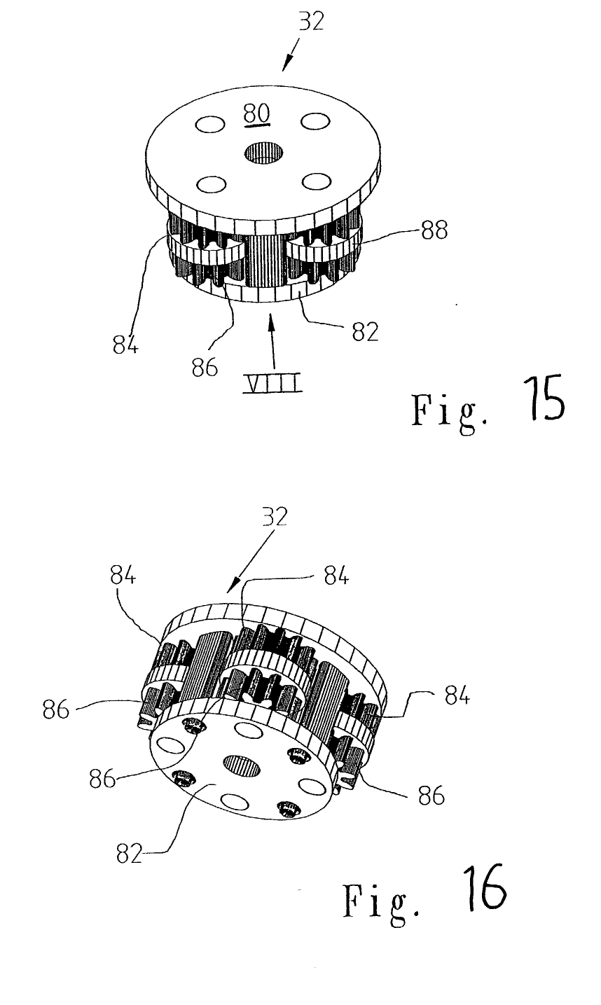

Each of the two drives 18 and 20 has, at their lower sides, a projection 38 and 40, respectively, for actuating the fixture portions 22 and 24. The projection 38 engages the conventional pivot fixture 22 (see FIGS. 1 to 8f) thereby permitting displacement of same in the fixture groove 42 within the door or window sash 10. The pivot fixture 22 corresponds to the pivot fixture of conventional pivot-tilt windows and doors, such as that illustrated in FIGS. 1 to 8f. The projection 40 has an eye 44 for mounting a shackle 46 e.g. by means of a rivet, pin or the like. The shackle 46 is schematically shown in FIGS. 11 and 14 and is hooked with its free end 48 into a closing plate 50 located on the stationary frame 51 (FIG. 14).

As is clearly shown, each of the two drives 18 and 20 comprises a toothed rod section 52 and 54 into which the teeth of two toothed wheels 56 and 58 engage (FIG. 13). The two toothed wheels 56 and 58 may be formed from one or two pieces. Only a portion of the circumference of the two toothed wheels 56 and 58 has teeth. On those sections where one toothed wheel has no teeth, the other toothed wheel is provided with teeth. This ensures that, during rotation of both toothed wheels 56 and 58 (which are connected to one another for secure mutual rotation), either the one toothed rod section 52 or the other toothed rod section 54 is moved. If e.g. the toothed wheel 56 of FIG. 13 is rotated in a counter-clockwise direction, the toothed wheel 58 comes out of engagement with the toothed rod section 54 and the teeth of the toothed wheel 56 engage in the teeth of the toothed rod section 52 and move same from the upper left to the lower right (in the arrangement according to FIG. 13). The teeth of the toothed wheel 56 correspondingly disengage the toothed rod section 52 when the toothed wheel 56 is turned in a clock-wise direction, wherein the teeth of the toothed wheel 58 engage the toothed rod section 54 and move same from the lower right to the upper left. The respective other toothed rod section is then in neutral.

FIGS. 9 and 11 show conical recesses 60 and 62 provided in the drives 18 and 20. The guiding bed 34 has an arm (not shown) disposed between the two drives 18 and 20 and having a further recess in which a sphere is disposed. The diameter of the sphere is larger than the separation between the two drives 18 and 20 such that the sphere, which laterally protrudes past the guiding bed 34 arm in which it is held, engages into the two recesses 60 and 62. When one of the two drives 18 or 20 is moved, the recess 60 or 62 is moved out of the alignment shown in FIG. 9 thereby pushing the sphere out of its recess 60 or 62 and disposing it into the other recess 62 or 60. This means that the drive into which the sphere engages is locked via the sphere to the guiding bed 34 arm. The other drive is freely movable. As soon as the two recesses 60 and 62 are once more aligned, the other drive can be moved out of this neutral position, with the sphere thereby being displaced into the recess of the other drive such that this other drive is locked to the guiding bed 34 arm. The recesses 60 and 62 and the sphere form a locking element 64 to ensure that only one of the drives 18 and 20 can be moved at a given time.

FIG. 13 also illustrates a hollow wheel 66 which is part of the differential transmission 32 and is disposed on the two toothed wheels 56 and 58 for secure mutual rotation therewith. The hollow wheel 66 can thereby connect the two toothed wheels 56 and 58 should this not already have been effected.

FIG. 14 shows a side view of the door or window sash 10 in a closed and tilted position. The door or window sash 10 can be tilted in the direction of arrow 68. The door or window sash 10 is thereby moved and retained by the shackle 46 forming the tilt fixture 24. The free end 48 of the shackle 46 comprises a pin held in the locking element 50, which is located in a recess 70 in the stationary frame 51. The closing plate 50 is shown separately in FIG. 14 for reasons of clarity. The closing plate 50 is usually in the plane of the tilt fixture 18, i.e. in the plane of the fixture groove of the door or window sash 10. The closing plate 50 comprises a translating part 72 for opening and closing the recess 70 to capture or release the pin provided at the free end 48. In FIG. 14, the translating part 72 is in the closed position and is displaced by means of a locking pin 74 of the pivot fixture from its released position into its open position and back. The locking pin 74 engages into a corresponding pin recess 76 when the door or window sash 10 is closed.

When the free end 48 of the shackle 46 is locked in the closing plate 50 and is therefore stationary, and the drive 20 is moved in FIG. 9 from the upper left to the lower right, the projection 40 is also moved from the upper left to the lower right, wherein the end 78 mounted to the projection 40 is displaced along the door or window sash 10 in a downward direction, thereby pivoting out the shackle 46 and tilting the door or window sash 10 (shown in FIG. 14 with dash-dotted lines).

FIG. 15 shows a perspective view of the differential transmission 32 with the crank 28 disposed on its upper side 80. The crank 28 serves for driving the upper side 80 and a retainer 82. Four toothed wheels 84 and 86 are each rotatably disposed in this retainer 82 in two planes, one on top of the other (shown in FIG. 16). The two toothed wheels 84 and 86 are connected to one another for secure mutual rotation. This is effected (as shown in FIG. 15) either via an intermediate disc 88 or directly (as shown in FIG. 16). The part of the differential transmission 32 shown in FIGS. 15 and 16 is inserted into the hollow wheel 66 (FIG. 13) such that the toothed wheels 86 engage in the inner toothed wheel 90 of the hollow wheel 66. A hollow wheel (not shown) is disposed onto the toothed wheels 84 and is connected to the cylindrical section 26 of the housing 12 and thereby fixed.

When the transmission 32 is driven by the crank 28, the toothed wheels 84 turn about the stationary hollow wheel connected to the housing 12 thereby driving the hollow wheel 66 since the two toothed wheels 84 and 86 have different numbers of teeth.

The pivot function of the door or window sash 10 is effected by a first drive 18 via a separate pivot fixture 22, whereas the tilt function of the door or window sash 10 is effected by a second drive 20 and a second tilt fixture 24. For this reason, the invention can replace the rotating handle 15′ of the conventional mechanism of FIGS. 1 to 8f and utilize portions of that conventional pivot-tilt mechanism to effect the pivot function. The tilting function is controlled by the additional tilt fixture 24, with shackle 46. When the door or window sash 10 is completely locked, the pivot fixture 22 is initially moved by the drive 18 and crank 28 from the upper into an intermediate position in which the locking pins 74 and 92 release the door or window sash 10 for rotation. When the crank 28 is moved further, the pivot fixture 22 is displaced into its final position in which the door or window sash 10 is locked such that it can only be tilted. In this neutral position, the pivot fixture 22, in particular the drive 18, is decoupled from the crank 28 thereby coupling the drive 20 and the tilt fixture 24. When the crank 28 is turned further, the door or window sash 10 is tilted in correspondence with the crank rotation. This means that each intermediate position between the closed door or window sash 10 and the completely tilted door or window sash 10 can be assumed. The differential transmission 22 is designed such that it is self-locking, wherein the door or window sash 10 reliably retains each intermediate position. Tilting of the door or window sash 10 is merely effected by the tilt fixture 24 and not by the pivot fixture 22, which remains in its neutral position.

FIG. 17 shows a further embodiment of a drive having a central translating part 94, two further translating parts 96 and 98 and locking devices 100, 102 provided in a housing (not shown). The central translating part 94 is disposed in the housing and can be displaced in the longitudinal direction thereof via a crank, a turning handle or another actuating element. The central translating part 94 thereby actuates the locking devices 100, 102 (formed as control discs) via two laterally projecting pins 104. The control discs 100, 102 are rotatably disposed in round recesses of the two translating parts 96 and 98 and comprise receiving slots 106 into which the pins 104 engage. When e.g. the central translating part 94 is moved from the left to the right, the control discs 100, 102 into which the pins 104 engage, are turned by approximately 90° in a clockwise direction. The pin facing away from the observer and engaging in the control disc 100 is then retained and actuates the first translating part 96. The rotary position of the control disc 100 is secured in that a securing pin 108 projecting from the control disc 100 is disposed within a cam guide 110 provided e.g. in a housing wall 112. The first translating part 96 is thus displaced by the central translating part 94 in an outward direction (in FIG. 17 towards the right). When the central translating part 94 is pushed back, the first translating part 96 is also carried along until it once more assumes the position shown in FIG. 17.

When the central translating part 94 in FIG. 17 is moved towards the left, the two control discs 100, 102 into which the pins 104 engage, are turned in a counter-clockwise direction through approximately 90° such that they assume the position shown in FIG. 17. The pin 104 facing the observer is then captured in the control disc 102 and actuates the second translating part 98. The turned position of the control disc 102 is secured by a securing pin 114 projecting from the control disc 102 and disposed in a cam guide 116, provided e.g. in a housing wall 118.

The translating part 98 or 96 which is not actuated by the central translating part is blocked at the end of the cam guide 116 or 110 by its associated housing wall 118 or 112.

The translating parts 94, 96 and 98 may be relatively flat or thin such that this drive can be easily accommodated in a door or window sash. Moreover, the central translating part 94 can drive, via the first translating part 96, either the pivot fixture or, via the second translating part 98, the tilt fixture, wherein the respective other fixture remains at rest.

We claim:

1. A pivot-tilt mechanism for a window or door, the mechanism comprising:
a pivot fixture;
a tilt fixture;
a first drive communicating with said pivot fixture;
a second drive communicating with said tilt fixture; and
an actuating means communicating with both of said first drive and said second drive for sequential operation of said pivot fixture and said tilt fixture.

2. The pivot-tilt mechanism of claim 1, wherein said pivot fixture is driven when said tilt fixture assumes a neutral position and wherein said tilt-fixture is driven when said pivot fixture assumes a neutral position.

3. The pivot-tilt mechanism of claim 1, wherein said actuating means comprises a central translating part, wherein said first drive comprises a first translating part communicating with said pivot fixture and wherein said second drive comprises a second translating part communicating with said tilt fixture, wherein said central translating part drives said first and said second translating parts.

4. The pivot-tilt mechanism of claim 3, wherein one of said first and said second translating parts is decoupled from said central translating part when a respective other one of said first and said second translating parts is coupled to said central translating part.

5. The pivot-tilt mechanism of claim 4, further comprising means for coupling and decoupling said first and said second translating parts to and from said central translating part.

6. The pivot-tilt mechanism of claim 1, wherein said actuating means comprises a crank for moving said first and said second drives.

7. The pivot-tilt mechanism of claim 1, wherein said actuating means comprises a toothed gearing.

8. The pivot-tilt mechanism of claim 7, wherein said toothed gearing comprises a differential transmission.

9. The pivot-tilt mechanism of claim 1, wherein said first drive comprises a first toothed rod and said second drive comprises a second toothed rod.

10. The pivot-tilt mechanism of claim 9, wherein said first and said second toothed rods are disposed proximate to one another, said actuating means comprising a first toothed wheel communicating with said first toothed rod and a second toothed wheel communicating with said second toothed rod, wherein said first toothed wheel and said second toothed wheel are disposed one on top of the other, with said actuating means further comprising means for motionally coupling said first toothed wheel to said second toothed wheel.

11. The pivot-tilt mechanism of claim 10, wherein said first toothed wheel has first teeth along only a part of an entire circumference thereof and said second toothed wheel has second teeth along only a part an entire circumference thereof, wherein said first and said second teeth sequentially engage said first and said second toothed rods.

12. The pivot-tilt mechanism of claim 10, wherein said actuating means further comprises toothed gearing having a differential transmission, wherein said differential transmission drives said first and said second toothed wheels.

13. The pivot-tilt mechanism of claim 9, further comprising a housing and locking means, said locking means cooperating with said first and said second toothed rods to sequentially lock said first and said second toothed rods to said housing such that only one of said first and said second toothed rod sections can be driven at a same time.

14. The pivot-tilt mechanism of claim 13, wherein said locking means comprises a locking element which is driven by one of said first and said second toothed rods and which locks another one of said first and said second toothed rods to said housing.

15. The pivot-tilt mechanism of claim 14, wherein said locking element always re-assumes an unlocked position when changing from said first drive to said second drive and when changing from said second drive to said first drive.

16. The pivot-tilt mechanism of claim 1, wherein said tilt fixture comprises a pivoting shackle communicating with said second drive.

17. The pivot-tilt mechanism of claim 16, wherein a free end of said shackle can be hooked into a closing plate provided on a stationary window or door frame.

18. The pivot-tilt mechanism of claim 17, wherein said closing plate is open when said pivot fixture assumes an unlocked position.

19. The pivot-tilt mechanism of claim 1, wherein said actuating means comprises means for driving said first and said second drives using a motor.
